(19) United States
(12) Patent Application Publication
(10) Pub. No.: US 2008/0256205 A1
(43) Pub. Date: Oct. 16, 2008

(54) Apparatus and Method for a Portable Hand Held Device Into a Media Controller

(76) Inventor: Shawn Christopher Mahoney, Astoria, NY (US)

Correspondence Address: PROSKAUER ROSE LLP;PATENT DEPARTMENT, 1585 BROADWAY, NEW YORK, NY, 10036-8299, US

(21) Appl. No.: 12/029,371

(22) Filed: Feb. 11, 2008

Related U.S. Application Data
(60) Provisional application No. 60/903,367, filed on Feb. 26, 2007.

(51) Int. Cl. G06F 15/16

(52) U.S. Cl. 709/206; 709/227

(57) ABSTRACT

A portable handheld electronic device, such as a cellular telephone, PDA, or gaming console, is disclosed that can be configured to initiate and control a media presentation at a display terminal. The media presentation originates from a media server. The handheld device provides functionality similar to a typical television remote control through the use of wireless transmissions, including Short Message Service (“SMS”) text messages and Instant Messages (“IMs”).

### CROSS REFERENCE TO RELATED APPLICATIONS

This application claims the benefit of U.S. provisional application 60/903,367, filed Feb. 26, 2007.

### FIELD OF THE INVENTION

The present invention relates to the use of a cellular telephone, or other similar portable handheld electronic devices, as a remote control. The inventive control uses wireless transmissions, including SMS text messages and IMs to control the display of a media presentation that originates from a media server.

### BACKGROUND OF THE INVENTION

It has become commonplace for home computer and other similar devices, including gaming systems and Internet appliances, to be used as entertainment centers for viewing videos and listening to music. Some of this content originates from Internet servers that broadcast and stream content to authorized persons with Internet access.

One possible factor limiting the use of such services is the lack of a comfortable, easy to use, and flexible control mechanism. For example, some users find it uncomfortable and inconvenient to control an Internet television presentation with a mouse. Users prefer the feel and function of standard television remotes.

are then limited to viewing their programming on computers employing such a control, and unable to view a service on any computer connected to the Internet at any location.

Additionally, prior art remote controls require the user to be in close proximity to the display device to operate the remote control. A user cannot control a display device from any location.

Additionally, there presently does not exist a mechanism to gather marketing data, contact data, demographic data, and other advertising data, about users and their viewing preferences for such media presentations regardless of the location and device of display.

What is needed is a flexible remote control for a controlling the display of a media presentation on a computer in a manner similar to a standard television remote control, while not being permanently associated with a single display device. A system for gathering marketing data associated with a control device, rather than a particular display device, is also needed.

### SUMMARY OF THE INVENTION

The present invention utilizes a portable handheld computing device that a user would typically carry with them for other purposes, such as a cell phone or personal digital assistant (“PDA”), to initiate and control a media presentation on a display device that originates from a remote media server. The signals sent by the portable handheld computing device may be captured and analyzed at a central location to generate marketing data on the viewing habits of the user, regardless of the location of viewing.

The present invention allows a user, at any location, to request that a media presentation be downloaded, buffered, or otherwise ordered for viewing at a future date, at any given display location, such that the program will be ready to be viewed at a desired time.

The portable handheld computing device runs a communication application program in a preferred embodiment. A communication link is established between the portable handheld computing device and a media server. Using the portable handheld computing device a display device is selected, and a communications link is established between the portable handheld computing device and the display device. The display device may be running a display applications program. The portable handheld computing device may send a first control signal to initiate a media presentation on the display device and may send a second control signal to change a characteristic of the media presentation.

In a second preferred embodiment, marketing data is determined from the control signals of the portable handheld computing device. The media presentation may be altered based upon the identified marketing data, such as with the addition of targeted advertising.

These and other advantages and features of the present invention may be discerned from reviewing the accompanying drawings and detailed description of the invention.

### BRIEF DESCRIPTION OF THE DRAWINGS

The present invention may take form in various components and arrangements of components and in various steps and arrangement of steps. The drawings are only for purposes of illustrating a preferred embodiment and are not to be construed as limiting the invention.

FIG. 1 is a flow chart of the operation of the initiation of a media presentation by a media server in response to a control signal from a handheld device according to an exemplary preferred embodiment of the present invention.

FIG. 2 is a flow chart of the changing of a characteristic of a media presentation by a media server in response to a control signal from a handheld device according to an exemplary preferred embodiment of the present invention.

FIG. 3 is a diagram of a system for displaying and controlling a media presentation according to an exemplary preferred embodiment of the present invention.

FIG. 4 is a diagram of a display device for displaying a media presentation according to an exemplary preferred embodiment of the present invention

FIG. 5 is a diagram of a media server for distributing a media presentation according to an exemplary preferred embodiment of the present invention

FIG. 6 is a diagram of a portable handheld device for controlling a media presentation according to an exemplary preferred embodiment of the present invention

### DETAILED DESCRIPTION OF THE DRAWINGS

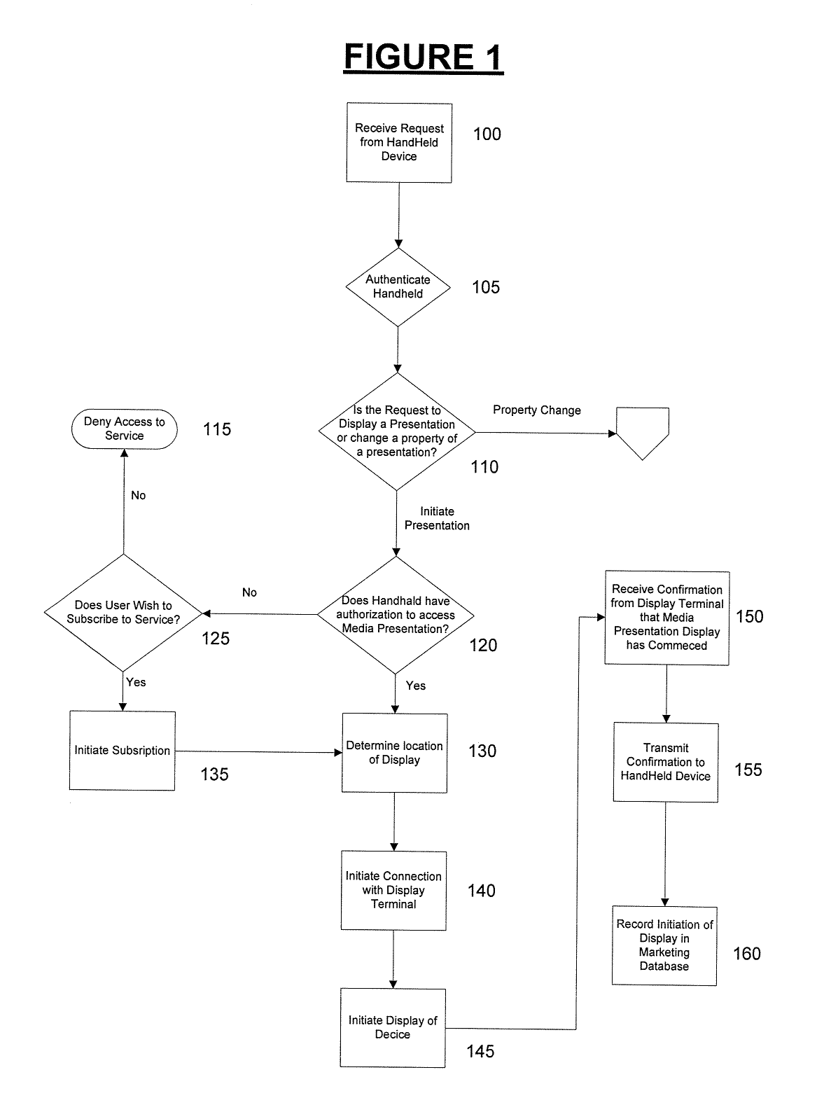

As shown in FIG. 1, a media server receives a request from the portable hand-held device to either initiate the display of a media presentation or change a characteristic of a media presentation. Step 100. The handheld device can be a cell phone, PDA, blackberry, portable gaming device, or other typical routinely carried handheld electronic device, that can be adapted to function according to at least one embodiment of the present invention.

As non-limiting examples, a media presentation can include such things as streaming video, music, digital images, internet television, and any other desired media content. Characteristics of the display of the media presentation may include such things as channel, volume, display size, or other similar such properties.

At Step 105, the media server authenticates the request received from the handheld device. The authentication process may confirm the identity of the handheld device and its user, and determine any applicable permissions. For example, the media server may determine what media presentations a given user will have access to, and under what conditions. The authentication process may also determine if the request received is in a valid format, meets appropriate security requirements, and is decodable.

At Step 110, the media server determines whether the request made by the authenticated handheld device is to initiate the display of a media presentation or change a property of a presentation. Assuming the request is to initiate the display of a media presentation, the media server confirms whether the handheld device is authorized to access the requested media presentation at Step 120. The media server may give the user a chance to subscribe to such service it if is determined that access to the requested media presentation is not authorized. Step 125. Access may be denied if the user does not want to subscribe. Step 115. Otherwise, the media server may initiate a subscription by, for example, collecting payment or registration information. Step 135. The user may have a standing account with the media server or such account can be established on a case by case basis. The present invention supports centralized billing, where, for example, a user's cable television account may be associated with the handheld device used as a control, rather than a display device, as is presently typical. For example, in a preferred embodiment, the user's cable bill can be combined with the phone bill for the cellular telephone being operated as a handheld control. The user's ability to access cable services is de-coupled from a given location, and access at any location with a display device is supported.

If access to the media presentation is authorized, the media server determines the desired location of display. Step 130. This location may be configured in advance as a part of the setup of a user's account or may be included as a part of the display request. The media server can then initiate a connection with the display terminal. Step 140. This connection could be, for example, over the Internet. As a part of the establishment of the connection, or at any other point in the process, the media server may check the connection to make sure it meets certain requirements needed to support the media presentation, such as bandwidth, or speed. Certain display devices may be unsuitable for displaying certain media presentations because they have, for example, the wrong size screen or lack speakers. An error code may be generated, and the request for display rejected if the available connection to the display device or the display device itself is insufficient for a given purpose. Alternatively, the media server may automatically adjust a property of the media presentation, such as resolution, to appropriately adapt it for use on the connection and display device.

In one embodiment of the invention, the media server restricts the location of display to a particular display device, such as through the use of a particular device's Internet address to prevent unauthorized further dissemination of the media presentation. This could be accomplished, for example, by the use of an Internet Protocol (“IP”) address or other such identifier to generate a passcode or key.

After the connection is satisfactorily established, the media server can initiate the display of the media presentation requested on the display device. Step 145. The display device may send a confirmation to the media server that the display of the media presentation has commenced. Step 150. Alternatively, if there is a problem with the display of the media presentation, the display device may inform the media server, so appropriate adjustments can be made. As desirable, the media server can report confirmations or other information received from the display device to the hand held device. Step 155. Such information may also be transmitted by the media server to the handheld device earlier, for example, the media server may send a confirmation to a handheld device after the connection of the display device has been established at Step 140, or after determining if the location of display is valid at Step 130.

In a preferred embodiment of the invention, the media server can record the initiation of the media presentation in it's marketing data base. Step 160. One benefit of this capability is that a user's preferences can be tracked no matter which display device is used. This information can be used, for example, to determine a user's viewing preferences and target programming or advertisements to the user.

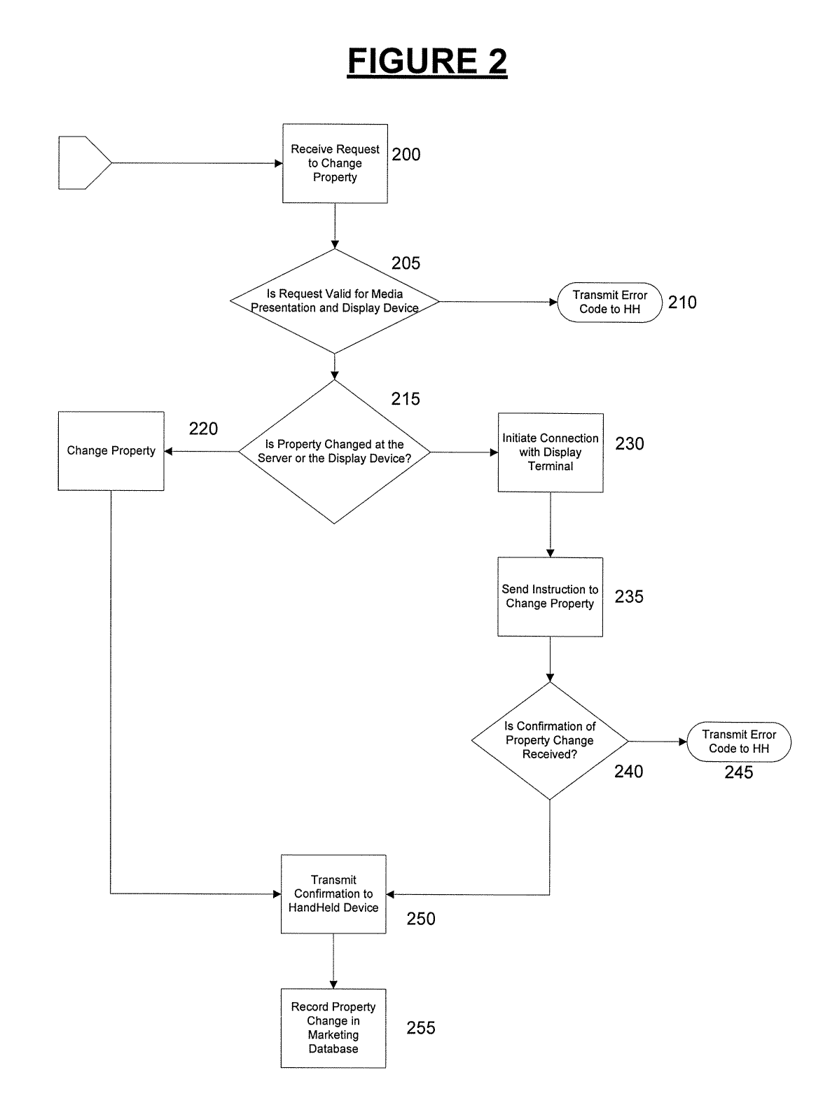

If the request from the handheld device is to change a property of the presentation, as shown at Step 200 of FIG. 2, the media server first determines if the request is valid for the given media presentation and display device. Step 205. For example, certain display devices may only support a certain resolution, certain volume, or have content restrictions, such as parental controls designed to prevent access to inappropriate content. In any of those cases, the server can transmit an error code to the handheld device. Step 210.

Assuming the request for a property change is valid, the media server determines whether the property can be changed locally at the media server or whether the property needs to be changed at the display device. Step 215. For example, changing channels of an Internet television program may be accomplished at the source by simply streaming a different channel of the television to the computer or at the computer by decoding a different channel from a data stream that contains multiple channels. As another example, volume typically would need to be changed at the display device. In the case where the property can be at the media server, this can be accomplished at Step 220. Assuming the property cannot be changed at the media server it may be changed at the display terminal at Step 230, where a connection may be initiated with the display terminal (or an existing connection exploited) and an instruction to change the property will be sent from the media server to the display device. Step 235. In another embodiment, the handheld control device itself determines whether the property needs to be changed at the media server or at the display device, and in the latter event, sends the request for change directly to the display device.

After the request has been received and processed by the display device, and the property changed, the display device will send a confirmation back to the media server. Step 240. The media server will determine if instruction has been received, and if so, has the property been changed. In the event the media server is unable to communicate with the display device, or does not receive confirmation of the property change, an error code may be transmitted at Step 245. After ascertaining the status of the property change, confirmation of the change may be transmitted to the hand-held device. Step 250.

At Step 255, the property change may be recorded in a marketing database located at the media server or elsewhere. For example, if the user has changed Internet television channel, the media server may record this change, and analyze it to understand viewing preferences. Additionally, other characteristics of the viewer can be recorded and appropriately processed, either at the server or remotely.

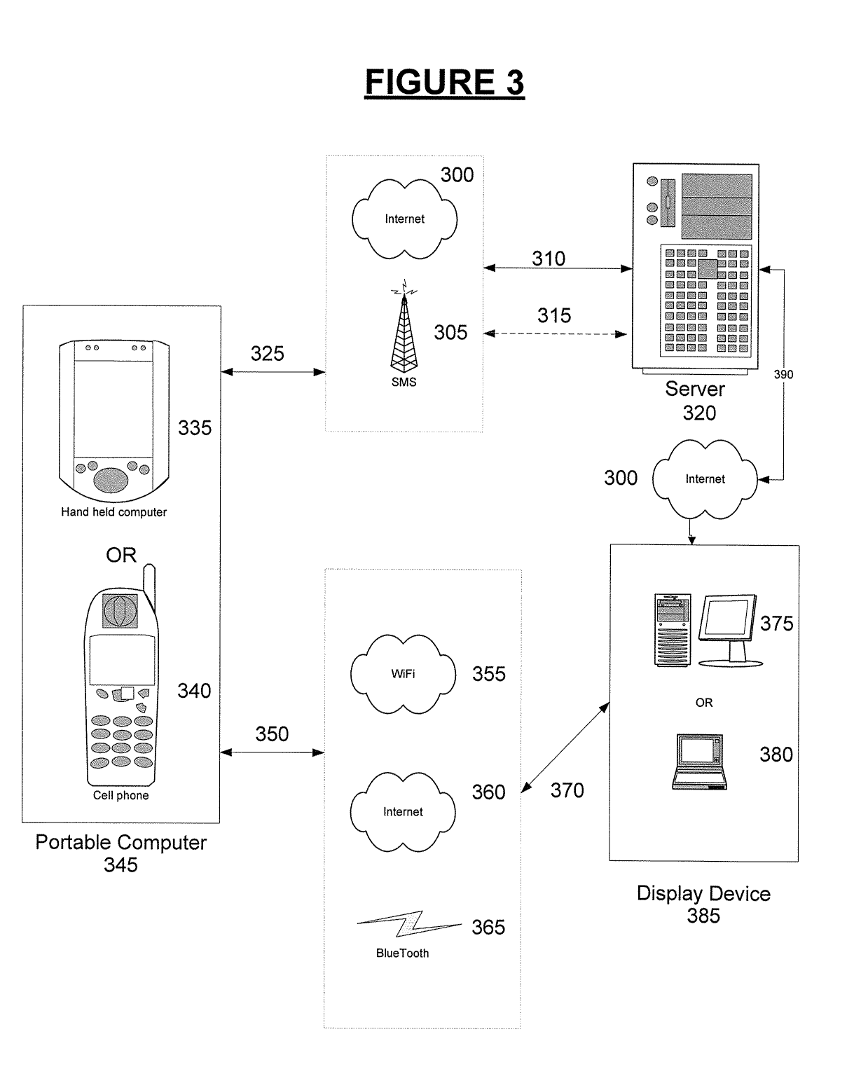

A diagram of the exemplary physical devices that can be adapted for use with the present invention, and exemplary communication paths is shown in FIG. 3. In a first embodiment, portable device 345 communicates directly with media server 320 through the use of the Internet 300, typical cellular text messages (SMS) 305 or other similar typical wireless medium. Portable handheld computing device 345 may be any type of portable computer not typically used as a remote control for a media presentation, such as a PDA 335 or cellular telephone 340.

In another embodiment, handheld device 345 communicates with media server 320 through display device 385. In this embodiment, the handheld device 345 establishes a connection with display device 385 through the use of WiFi 355, the Internet 360 or Blue tooth connection 365. The display device can be any device with suitable access to the media server, and sufficient processing and display capabilities, such as a typical desktop computer 375 or laptop 385. In another embodiment, the display device could be any electronic media center, such as a gaming system or Internet appliance that provides suitable communications, processing, and display capabilities. The display device 385 then forwards the communication from the handheld device 345 to the media server 320, through, for example, the Internet 300. In this way, the display device 385 functions as a relay for communications between the handheld device 345 and the media server 320.

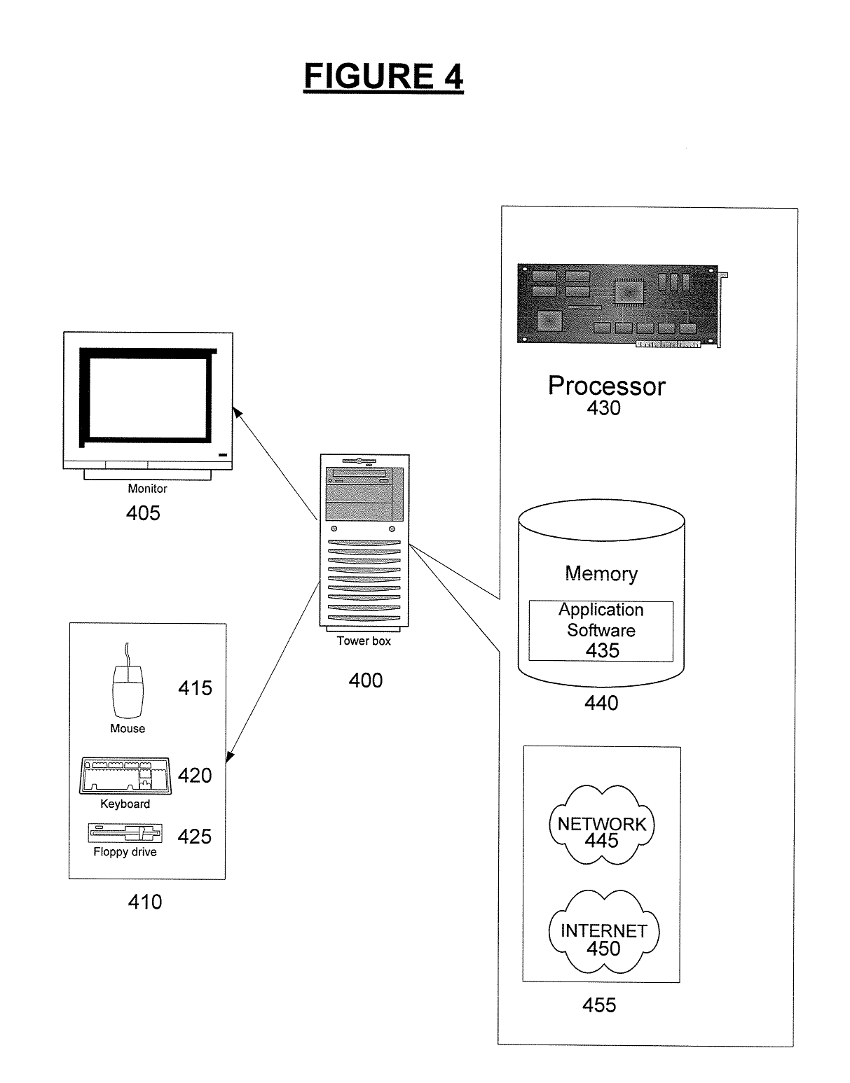

FIG. 4 is a diagram of an exemplary display device, comprising housing 400, peripherals 410 and monitor 405. Within housing 400 resides processor 430, memory 440, and network connection 455. The network connection 455 can include both local area network connection 445 and Internet connection 450. Peripherals 410 can include mouse 415, keyboard 420, or floppy drive 425 or other suitable devices.

In one embodiment, application software may reside inside memory 440. This application software may be designed to work only to support the inventive functionality or may be multi-purpose, such as a standard media player or Internet browser. Application software 435 is executed and controlled by processor 430.

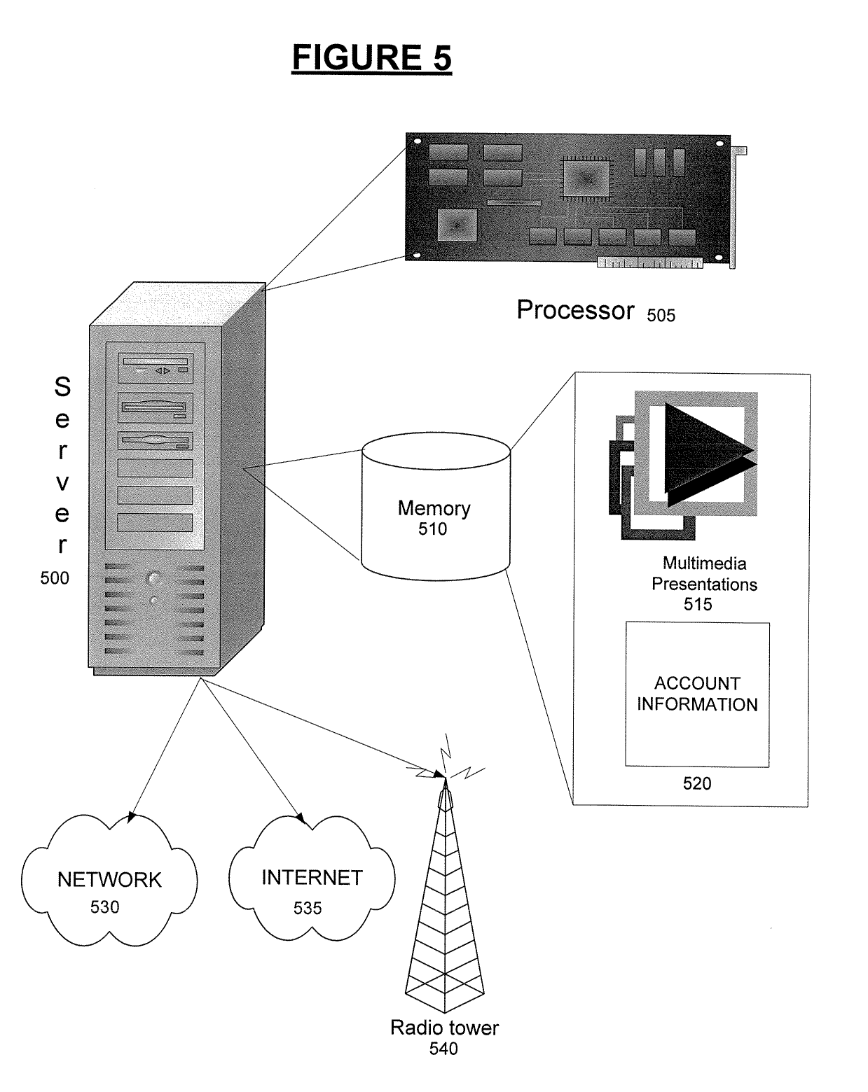

FIG. 5 shows a media server 500 according to one embodiment of the present invention. The media server has a processor 505, memory 510, and the ability to communicate through network 530 or Internet 535. In the case where handheld device 345 communicates with the media server 500 through a text message (SMS) or other wireless cellular communication, there may be an intermediate cellular network, not shown, and an network interface configured to forward the communication to the media server 500 in a suitable format, also not shown. The SMS may be forwarded, for example, through Internet connection 535 or network connection 530.

Memory 510, which may be any suitable form of electronic storage, for example, a hard drive or volatile memory, may contain account information 520, and at least one multi-media presentation 515. Memory 510 may be local to media server 500 or remote. Account information 520 may include the location of display devices associated with each account, the identification of authorized users, payment information, security information, such as passwords, or other required information.

Media server 500 may have a marketing database 525 that contains marketing information recorded from user activity. In one embodiment of the present invention, information gathered by the marketing database may be used to facilitate targeted communications to the handheld device by either the media server or a content provider, such as a television station or a movie studio. For example, if it is determined that a user likes a certain genre of programming, a text message or e-mail may be sent to the handheld device prompting the user to tune in to a specific media presentation. In one embodiment of the present invention the targeted message may include a link or other information necessary to initiate the recommended or advertised media presentation.

In one embodiment, the handheld device requires no special software or user interface. Text messages or IMs could be sent in a specified, pre-determined format to an address corresponding to a server. The messages could indicate, for example, the identity of the user, login information, the identity of the display device, and the action requested.

In another embodiment, software could be loaded onto the handheld device to correlate regular buttons, such as those on a cell phone, with available media options. The software could, for example, automatically generate specialized text messages to be sent to a server in response to a press of a particular button. A similar methodology could also be employed with any available communication mechanisms of the handheld device, such as the use of Instant Messages, or accessing a URL with an Internet browser on the handheld.

In another embodiment, a graphic user interface (“GUI”) “front end” is created that simulates the controls of a typical remote. The “back end” functionality may proceed otherwise as described above.

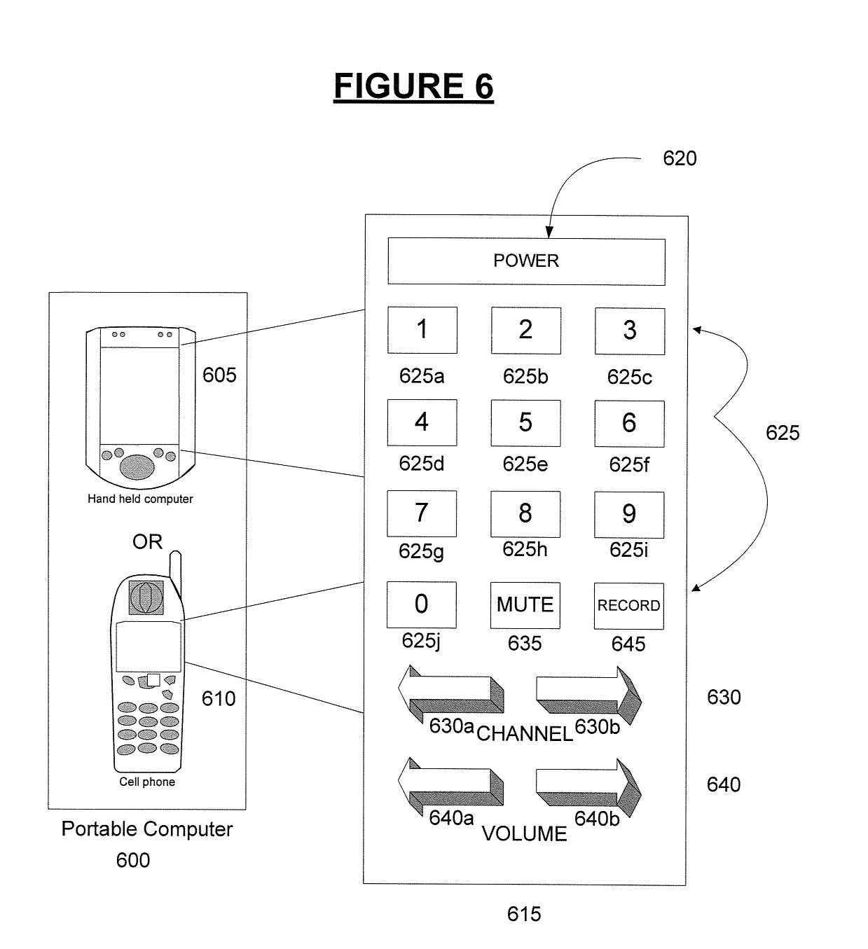

FIG. 6 shows a portable handheld device 600 according to a preferred embodiment. The screen of handheld portable computer 600 displays a GUI that simulates the appearance of a typical remote control. As shown in FIG. 6, the GUI is comprised of power button 620, channel control 625 A-625J, mute button 635, record button 645, channel up 630A and channel down functions 630 B, and volume up 640(a) and down 640B.

The GUI may be customizable, to allow the alteration of its appearance, or to add different buttons with desired functionalities. If the handheld device 600 has a touch-sensitive display, the user need only touch the appropriate button to trigger the generation and transmission of a suitable request message. In another embodiment, the GUI may visually associate pre-existing “hard” keys with certain control functionality that has been adapted to those keys.

In another embodiment of the present invention, the user may access a remote web page through a browser of the portable handheld device. The web page may appear to be a typical remote control and act as a GUI as described above.

In another embodiment of the present invention, the media server is configured to only work with certain types of handheld devices. For example, a given media server may partner with a cellular telephone provider, and allow access to that companies cellular telephones as a mechanism to boost sales of those phones.

In another embodiment, a media server can identify the type of handheld device being employed as a remote control and target advertisements in the media presentation to that device. For example, if the handheld device is manufactured by, or uses a carrier who, is a partner of the media server, the media server may add special advertisements to apprise users of special programs run by the partner. Additionally, advertisements of competitors to companies associated with the handheld device may be inserted into media presentations when the handheld device is associated with a competitor of a partner of the media server.

In another embodiment of the present invention, a user can employ the handheld computer to request that a media presentation be downloaded, buffered, or otherwise ordered for viewing at a future date, at any given location, such that the program will be ready to be viewed at a desired time.

While the present invention has been illustrated by the description of a preferred and alternative embodiments and processes, and while the preferred and alternative embodiments and processes have been described in considerable detail, it is not the intention of the applicant to restrict or in any way limit the scope of the appended claims to such detail. Additional advantages and modifications will readily appear to those skilled in the art. The invention in its broadest aspects is therefore not limited to the specific details, preferred embodiment, and illustrative examples shown and described. Accordingly, departures may be made from such details without departing from the spirit or scope of applicant's general inventive concept.

1. A method for controlling a media presentation with a portable computing device, wherein the portable computing device is running a communication application program and a device having a display is running a display applications program, the method comprising the steps of:
(a) establishing a communication link between the portable computing device and a media server;
(b) selecting the device having a display to display the media presentation;
(c) establishing a second communications link between the portable computing device and the device having a display;
(d) sending a control signal from the portable computing device through the use of the communications application program to initiate the media presentation on the device having a display; and
(e) sending a second control signal from the portable computing device through the use of the communications application program to change a characteristic of the media presentation.

2. The method of claim 1 wherein the device having a display is a personal computer.

3. The method of claim 1 wherein the portable computing device is a cellular telephone.

4. The method of claim 1 wherein the portable computing device is a Personal Digital Assistant.

5. The method of claim 1 wherein the display applications program is a web browser.

6. The method of claim 1 wherein the communications applications program provides a graphic user interface that simulates a television remote control.

7. The method of claim 1 further comprising the step of:
(f) accessing a location on the Internet; wherein the display applications program in an Internet browser

8. The method of claim 1 further comprised of the steps of:
(g) identifying marketing data at the media server based upon the control signal and the second control signal; and
(h) storing the marketing data in memory.

9. The method of claim 1 further comprising the step of:
(i) altering the media presentation based upon the identified marketing data.

10. The method of claim 1 wherein step (d) comprises entering an address of the device having a display in the communications application program on the portable computing device.

11. The method of claim 1 wherein step (d) is comprises selecting a device having a display name from a list of plurality of device having a display names in the communications application program on the portable computing device.

12. The method of claim 1 wherein step (d) comprises selecting the device having a display at the media server.

13. The method of claim 1 wherein the control signal is sent from the portable computing device to the media server.

14. The method of claim 1 wherein the communication link between the portable computing device and the media server is through the device having a display and the control signal and second control signal are sent from the portable computing device to the device having a display for subsequent communication to the media server.

15. The method of claim 1 wherein the control signal is an Short Message Service transmission.

16. The method of claim 1 wherein the characteristic of the media presentation is a channel selection.

17. A portable computing device for controlling a media presentation on a device having a display, the portable computing device comprising:
a first transceiver for establishing a communication link to a media server;
a second transceiver for establishing a second communication link to a device having a display; and
a processor for executing a communications application program; wherein the communications application program provides an interface to facilitate the selection of the device having a display to display the media presentation, a first routine configured to create a control signal to initiate the media presentation on the device having a display and a second routine to create a second control signal to change a characteristic of the media presentation.

18. The portable computing device of claim 17 wherein the portable computing device is a cellular telephone.

19. The portable computing device of claim 18 wherein the device having a display is a personal computer.

20. The portable computing device of claim 17 wherein the portable computing device is a Personal Digital Assistant.

21. The portable computing device of claim 19 wherein the device having a display is a personal computer.

22. The portable computing device of claim 17 wherein the device having a display is a personal computer.

23. The portable computing device of claim 21 wherein the communications applications program provides a graphic user interface that simulates a television remote control.

24. The portable computing device of claim 22 wherein the communications applications program provides a graphic user interface that simulates a television remote control.

25. The portable computing device of claim 17 wherein a charge for the media presentation is associated to the portable computing device.
